(19) United States
(12) Patent Application Publication
(10) Pub. No.: US 2018/0031012 A1
(43) Pub. Date: Feb. 1, 2018

(54) FLUID PRESSURE CYLINDER

(71) Applicant: KYB Corporation, Tokyo (JP)

(72) Inventors: Yasuhito TAKAI, Aichi (JP); Yuuki SHIMADA, Aichi (JP); Shusaku SAITA, Gifu (JP)

(73) Assignee: KYB Corporation, Tokyo (JP)

(21) Appl. No.: 15/548,787

(22) PCT Filed: Jan. 29, 2016
(86) PCT No.: PCT/JP2016/052771

§ 371 Date: Aug. 4, 2017

(30) Foreign Application Priority Data
Feb. 10, 2015 (JP) 2015-024358

(51) Int. Cl. F15B 15/22

(52) U.S. Cl. CPC F15B 15/225

(57) ABSTRACT

A hydraulic cylinder includes: a cylindrical cushion bearing that is clamped between a piston and a step portion of a piston rod; a cushion passage that is formed between the cushion bearing and a bearing receiving portion and that imparts resistance to the flow of the working oil passing therethrough; and a check seal that is provided between the inner circumference of the cushion bearing and the outer circumference of the piston rod. The check seal shuts off the flow of the working fluid from a connection gap between the piston rod and the piston towards the rod side chamber through the annular gap and allows the flow of the working fluid from the annular gap towards the bottom-side chamber through the connection gap.

### TECHNICAL FIELD

The present invention relates to a fluid pressure cylinder in which a piston rod is decelerated by a cushion pressure generated near a stroke end of the piston rod.

### BACKGROUND ART

As conventional fluid pressure cylinders, there is a known fluid pressure cylinder that includes a cushioning mechanism by which a piston rod inserted into a cylinder tube is decelerated by a cushion pressure generated when the piston rod comes to the vicinity of a stroke end.

JP2012-193752A discloses a fluid pressure cylinder that includes a piston rod inserted into a cylinder tube, a piston that is provided on a tip end of the piston rod and defines a rod side chamber and a bottom-side chamber in the interior of the cylinder tube, and a cushion bearing that defines a cushion passage through which working fluid is allowed to pass when the piston rod comes to the vicinity of a stroke end. With the fluid pressure cylinder disclosed in JP2012-193752A, the cushion bearing is clamped between the piston and a step portion formed on the piston rod.

### SUMMARY OF INVENTION

With a fluid pressure cylinder, in an event in which an excessive external force is exerted to a piston rod, the piston rod may be plastically deformed so as to be elongated in the axial direction. Among the fluid pressure cylinders having a clamped-type cushion bearing clamped between a step portion of the piston rod and a piston, there is a fluid pressure cylinder that has a function of detecting an abnormal state in which the piston rod is plastically deformed in the axial direction.

The fluid pressure cylinder having an abnormality detecting function has an annular gap between an inner circumference of the cushion bearing and an outer circumference of the piston rod. The annular gap inside the cushion bearing communicates with a bottom-side chamber through a connection gap between the piston rod and the piston. With the fluid pressure cylinder having such a configuration, when the piston rod is plastically deformed so as to be elongated, an axial gap is formed between the cushion bearing and the step portion of the piston rod, and a rod side chamber is communicated with the bottom-side chamber through the axial gap, the annular gap, and the connection gap. When the rod side chamber is communicated with the bottom-side chamber, even when a load-holding state is achieved by stopping the supply/ discharge of the working fluid to/ from the fluid pressure cylinder, the fluid pressure cylinder is slightly extended or contracted depending on the direction in which the load is applied. Therefore, with the fluid pressure cylinder having the abnormality detecting function, an operator can detect the abnormal state in which the piston rod is plastically deformed by checking whether the fluid pressure cylinder is extended or contracted in the load-holding state.

With the fluid pressure cylinder having such a configuration, in a normal state in which the piston rod is not plastically deformed, the cushion bearing is clamped between the step portion of the piston rod and the piston, and thereby, the gap formed in the axial direction between the cushion bearing and the piston rod is sealed. With such a configuration, in the normal state, because the communication between the rod side chamber and the bottom-side chamber through the annular gap and the connection gap is shut off, it is possible to achieve the load-holding state by stopping supply/discharge of the working fluid to/from the fluid pressure cylinder.

As described above, with the fluid pressure cylinder having the abnormality detecting function, it is possible to detect the abnormal state by shutting off the communication between the rod side chamber and the bottom-side chamber in the normal state and by allowing the communication between the rod side chamber and the bottom-side chamber through the annular gap when an abnormality has occurred.

However, in the fluid pressure cylinder having such a configuration, when the annular gap is provided inside the cushion bearing in order to detect the abnormal state, even in the normal state, the working fluid supplied to the bottom-side chamber may be guided to the annular gap through the connection gap between the piston rod and the piston. When the working fluid is guided to the annular gap, there is a risk that the cushion bearing is elastically deformed due to the pressure of the working fluid and is expanded in the radial direction. When the cushion bearing is expanded in the radial direction, the cushion passage formed between the cushion bearing and the bearing receiving portion is narrowed, and there is a risk in that stability of cushioning operation is deteriorated.

An object of the present invention is to improve stability of cushioning operation of a fluid pressure cylinder having an abnormality detecting function.

According to one aspect of the present invention, a fluid pressure cylinder includes a piston rod having an annular step portion formed on an outer circumferential surface; a cylinder tube into which the piston rod is inserted; a piston connected to a tip end of the piston rod, the piston being configured to slide along an inner circumferential surface of the cylinder tube, the piston defining a rod side chamber and a bottom-side chamber in an interior of the cylinder tube and; a cylindrical cushion bearing clamped between the piston and the step portion of the piston rod, the cushion bearing being provided so as to form an annular gap on the outer circumference of the piston rod; a bearing receiving portion into which the cushion bearing is allowed to enter at vicinity of a stroke end of the piston rod; a cushion passage formed between the cushion bearing and the bearing receiving portion as the cushion bearing enters inside of the bearing receiving portion, the cushion passage being configured to impart resistance to flow of working fluid passing therethrough; and a check seal provided between an inner circumference of the cushion bearing or the piston and the outer circumference of the piston rod. The check seal shuts off the flow of the working fluid from a connection gap between the piston rod and the piston towards the rod side chamber through the annular gap and allows the flow of the working fluid from the annular gap towards the bottom-side chamber through the connection gap.

### BRIEF DESCRIPTION OF DRAWINGS

FIG. 1 is a sectional view showing a part of a fluid pressure cylinder according to an embodiment of the present invention.

FIG. 2 is a sectional view showing a cushion bearing and a check seal of the fluid pressure cylinder according to the embodiment of the present invention.

FIG. 3 is a view showing a state in which the check seal of the fluid pressure cylinder according to the embodiment of the present invention is accommodated in an accommodating groove and is a sectional view showing a state in which a piston is not assembled.

FIG. 4 is a sectional view showing a state in which the check seal and the piston of the fluid pressure cylinder according to the embodiment of the present invention are assembled.

FIG. 5 is a view showing the check seal of the fluid pressure cylinder according to the embodiment of the present invention and is a sectional view showing a state in which the fluid pressure cylinder is extended.

FIG. 6 is a view showing a part of the fluid pressure cylinder according to the embodiment of the present invention and is a sectional view showing a state in which the fluid pressure cylinder is in an abnormal state.

FIG. 7 is a view showing the check seal of the fluid pressure cylinder according to the embodiment of the present invention and is a sectional view showing a state in which the fluid pressure cylinder is in the abnormal state.

FIG. 8 is a sectional view showing the check seal of the fluid pressure cylinder according to a comparative example of the embodiment of the present invention.

FIG. 9 is a sectional view showing the check seal of the fluid pressure cylinder according to a modification of the embodiment of the present invention.

### DESCRIPTION OF EMBODIMENTS

A fluid pressure cylinder according to an embodiment of the present invention will be described below with reference to the drawings. In the following, the case in which the fluid pressure cylinder is a hydraulic cylinder 100 that is driven by using working oil as working fluid will be described.

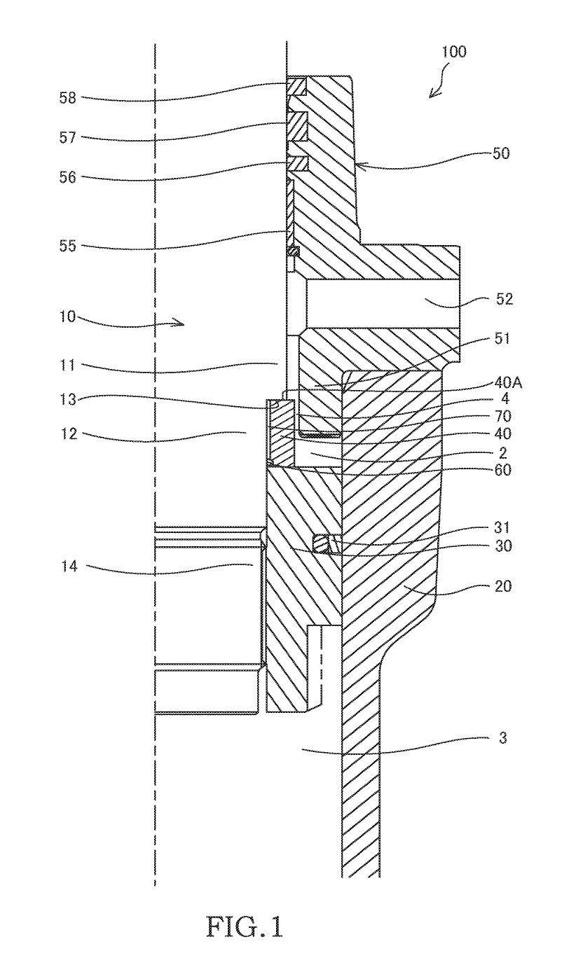

A configuration of the hydraulic cylinder 100 will be described with main reference to FIG. 1.

The hydraulic cylinder 100 is used as, for example, a bucket cylinder of a hydraulic shovel. A bucket (not shown) of the hydraulic shovel is rotated as the hydraulic cylinder 100 is extended/ contracted.

As shown in FIG. 1, the hydraulic cylinder 100 includes a piston rod 10 having an annular step portion 13 that is formed on an outer circumferential surface thereof, a cylindrical cylinder tube 20 into which the piston rod 10 is inserted, a piston 30 that is connected to a tip end of the piston rod 10 and slides along an inner circumferential surface of the cylinder tube 20, and a cylindrical cushion bearing 40 that is provided on an outer circumference of the piston rod 10.

An interior of the cylinder tube 20 is partitioned into a rod side chamber 2 and a bottom-side chamber 3 by the piston 30. The hydraulic cylinder 100 is extended/contracted by working oil pressure guided from a hydraulic pressure source (working-fluid pressure source) to the rod side chamber 2 or the bottom-side chamber 3. A gap between an inner circumference of the cylinder tube 20 and an outer circumference of the piston 30 is sealed by a seal member 31. With such a configuration, communication between the rod side chamber 2 and the bottom-side chamber 3 via the gap between the inner circumference of the cylinder tube 20 and the outer circumference of the piston 30 is shut off.

On an open end of the cylinder tube 20, a cylindrical cylinder head 50 is provided so as to slidably support the piston rod 10. The cylinder head 50 has a bearing receiving portion 51 that is inserted into the inside of the cylinder tube 20. The cylinder head 50 is fastened to the cylinder tube 20 with a plurality of bolts (not shown).

A bush 55, an auxiliary seal 56, a main seal 57, and a dust seal 58 are interposed on an inner circumference of the cylinder head 50.

The bush 55 is brought into sliding contact with the outer circumferential surface of the piston rod 10, and thereby, the piston rod 10 is supported so as to be movable in the axial direction of the cylinder tube 20.

A supply/discharge port 52 that is communicated with the rod side chamber 2 is formed on the cylinder head 50. The working oil is supplied/discharged to/from the rod side chamber 2 through the supply/discharge port 52.

The piston rod 10 includes a main body portion 11 that is in sliding contact with the inner circumference of the cylinder head 50, a small-diameter portion 12 that is formed to have a smaller outer diameter than the main body portion 11, the annular step portion 13 that is formed between the main body portion 11 and the small-diameter portion 12, and a screw portion 14 that is formed at a tip end of the piston rod 10 and to which the piston 30 is fastened.

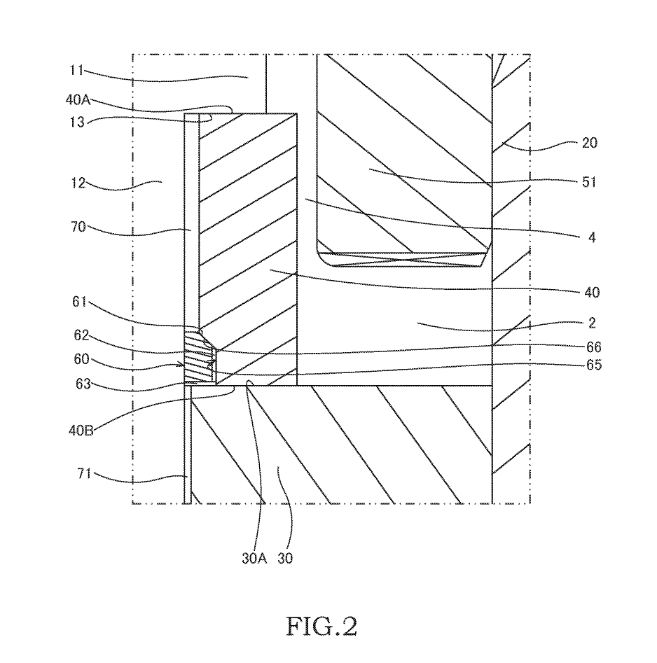

The cushion bearing 40 is provided on an outer circumference of the small-diameter portion 12 of the piston rod 10. As shown in FIGS. 1 and 2, the cushion bearing 40 is formed to have an inner diameter greater than an outer diameter of the small-diameter portion 12 of the piston rod 10. In other words, an annular gap 70 is provided between the cushion bearing 40 and the small-diameter portion 12 of the piston rod 10. In addition, the cushion bearing 40 is formed to have the inner diameter smaller than an outer diameter of the main body portion 11 of the piston rod 10. Thus, an one end surface 40A of the cushion bearing 40 is brought into contact with the step portion 13 of the piston rod 10.

As shown in FIG. 1, the piston 30 is threaded to the screw portion 14 of the piston rod 10 and is fastened to the piston rod 10 with a predetermined fastening force. Therefore, as shown in FIGS. 1 and 2, the cushion bearing 40 is clamped between the piston 30 threaded to the screw portion 14 of the piston rod 10 and the step portion 13 of the piston rod 10. With such a configuration, an axial gap between the cushion bearing 40 and the step portion 13 of the piston rod 10 and an axial gap between the cushion bearing 40 and the piston 30 are respectively sealed. Thus, communication between the rod side chamber 2 and the annular gap 70 inside the cushion bearing 40 is shut off.

As described above, the hydraulic cylinder 100 is a hydraulic cylinder having the clamped-type cushion bearing 40 that is clamped between the piston 30 and the piston rod 10 by fastening the piston 30.

A small gap may be formed between an inner circumference of the piston 30 and the outer circumference of the small-diameter portion 12 of the piston rod 10 and between the inner circumference of the piston 30 and the screw portion 14. Through such a small gap that is present on the outer circumference of the small-diameter portion 12 of the piston rod 10 and on the threaded portion of the screw, the annular gap 70 inside the cushion bearing 40 is communicated with the bottom-side chamber 3. In the following, the gap present between the inner circumference of the piston 30 and the outer circumference of the piston rod 10 is referred to as “a connection gap 71”. In addition, in FIGS. 2,4, and 5, the connection gap 71 is schematically shown as an annular gap.

The cushion bearing 40 is formed to have the outer diameter that is smaller than the inner diameter of the bearing receiving portion 51 of the cylinder head 50, and enters the inside of the bearing receiving portion 51 at the vicinity of a stroke end of the piston rod 10. As the cushion bearing 40 enters the inside of the bearing receiving portion 51, a cushion passage 4 is formed between the cushion bearing 40 and the bearing receiving portion 51. Resistance is imparted to the flow of the working oil passing through the cushion passage 4.

The hydraulic cylinder 100 further includes an annular check seal 60 that is provided between an inner circumference of the cushion bearing 40 and the outer circumference of the piston rod 10.

As shown in FIG. 2, the check seal 60 is provided in an accommodating groove 65 that is formed in the axial direction from an opposing surface 40B of the end surfaces of the cushion bearing 40. The opposing surface is opposing the piston 30. The accommodating groove 65 is formed so as to open to the opposing surface 40B of the cushion bearing 40 opposing the piston 30 and to open to an inner circumferential surface of the cushion bearing 40.

The check seal 60 has a tapered portion 61 at which an outer diameter is gradually increased along the axial direction from the one end surface in the axial direction. The other end surface of the check seal 60 is formed as a flat surface that is perpendicular to the central axis. In addition, a bottom portion 66 of the accommodating groove 65 in the axial direction is formed to have a tapered shape that corresponds to the tapered portion 61 of the check seal 60.

The check seal 60 is accommodated in the accommodating groove 65 such that the tapered portion 61 is brought into contact with the bottom portion 66 of the accommodating groove 65. As described above, because the check seal 60 has the tapered portion 61 and the accommodating groove 65 has the tapered bottom portion 66, it is possible to prevent misassembly of the check seal 60. In addition, because the tapered portion 61 of the check seal 60 and the bottom portion 66 of the accommodating groove 65 are in surface contact with each other at the tapered surfaces, sealing performance of the check seal 60 is improved. In order to prevent misassembly of the check seal 60, it is preferred that the check seal 60 has the tapered portion 61 and the accommodating groove 65 has the tapered bottom portion 66. However, the bottom portion 66 of the accommodating groove 65 may not be formed to have a tapered shape. For example, the bottom portion 66 of the accommodating groove 65 may be formed to have a flat surface that is perpendicular to the central axis. Even in this case, it is possible to prevent misassembly by providing the tapered portion 61 on one end portion of the check seal 60.

As shown in FIG. 2, the check seal 60 has an axial groove 62 that is formed on an outer circumferential surface thereof along the axial direction and a radial groove 63 that is formed on the end surface of the check seal 60 on the piston 30 side along the radial direction and communicates with the axial groove 62.

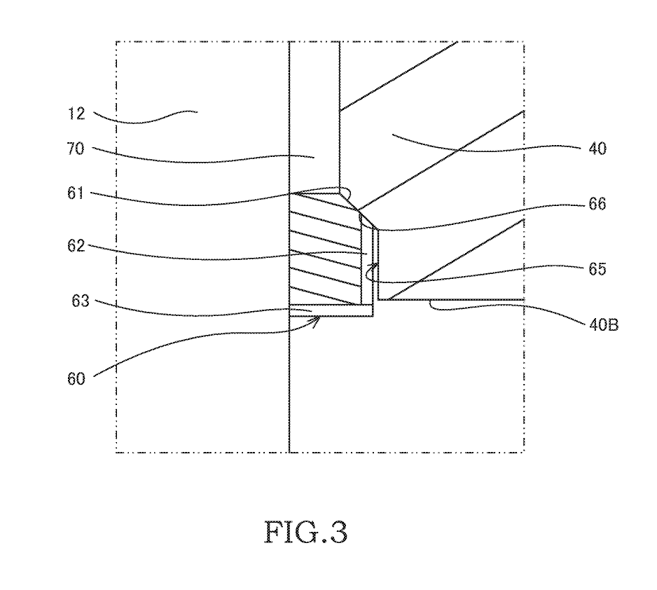

The check seal 60 is made of a resin material, such as, for example, rubbers, and is an elastic member capable of being deformed by an external force. As shown in FIG. 3, in a state accommodated in the accommodating groove 65, the check seal 60 projects out slightly from the opposing surface 40B of the cushion bearing 40 opposing the piston 30. Specifically, the check seal 60 is formed such that a natural length thereof in the axial direction in a state in which an external force is not exerted is longer than the length of the accommodating groove 65 in the axial direction.

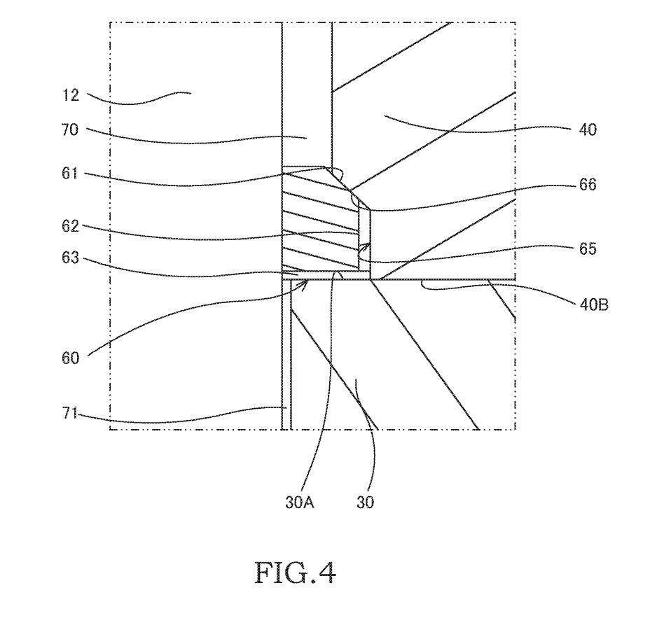

In the following, a process for assembling the check seal 60 and the cushion bearing 40 will be specifically described with reference to FIGS. 3 and 4.

As shown in FIG. 3, the cushion bearing 40 is first mounted on the outer circumference of the small-diameter portion 12 of the piston rod 10, and the check seal 60 is accommodated in the accommodating groove 65. In a state in which the check seal 60 is accommodated in the accommodating groove 65, the check seal 60 slightly projects out from the opposing surface 40B of the cushion bearing 40 opposing the piston 30.

Next, the piston 30 is threaded to the screw portion 14 of the piston rod 10. As the piston 30 is threaded to the screw portion 14 of the piston rod 10, an opposing surface 30A of the piston 30 opposing the cushion bearing 40 is brought into contact with the check seal 60. The piston 30 is further threaded from this state to bring the opposing surface 30A of the piston 30 and the opposing surface 40B of the piston rod 10 into contact with each other while compressing the check seal 60 in the axial direction. With such a configuration, as shown in FIG. 4, the check seal 60 is accommodated in the accommodating groove 65 by being compressed in the axial direction. The piston 30 is further fastened with a predetermined fastening force, thereby clamping the cushion bearing 40 with the step portion 13 of the piston rod 10.

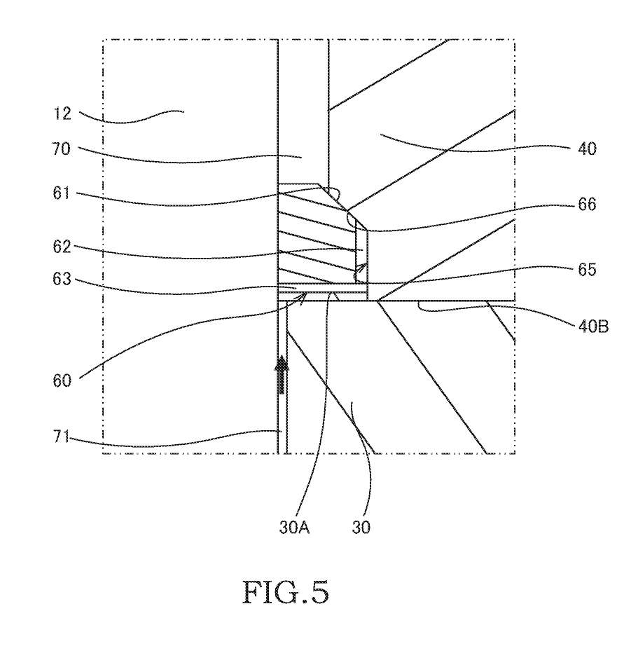

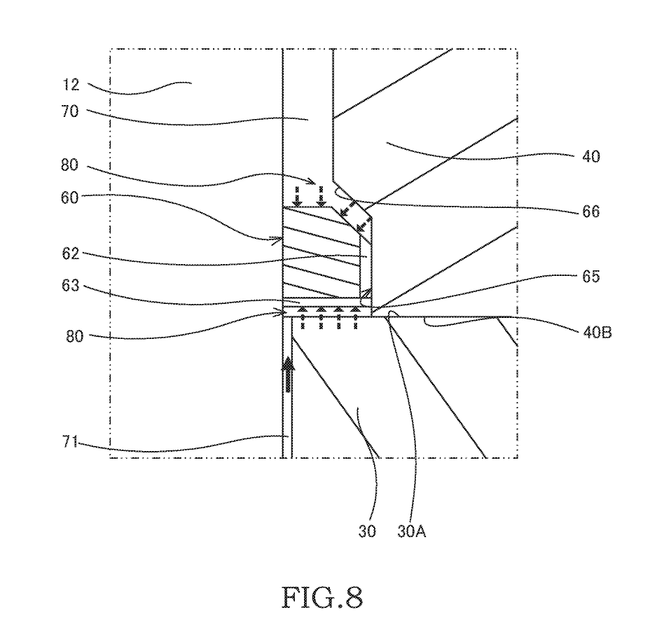

Next, an operation of the hydraulic cylinder 100 will be described with main reference to FIGS. 5 to 8. In FIGS. 5 to 8, flow of the working oil is schematically shown with solid line arrows. In FIG. 8, the pressure of the working oil acting on the check seal is schematically shown with broken line arrows.

When the hydraulic pressure source is communicated with the bottom-side chamber 3 and a tank (not shown) is communicated with the rod side chamber 2, the working oil is supplied to the bottom-side chamber 3, and the working oil in the rod side chamber 2 is discharged to the tank. Therefore, the hydraulic cylinder 100 is extended.

When the working oil is supplied to the bottom-side chamber 3, the pressure of the working oil acts on the check seal 60 through the connection gap 71 between the screw portion 14 of the piston rod 10 and the piston 30.

Therefore, as shown in FIG. 5, the check seal 60 is pressed against the cushion bearing 40 while being compressed in the axial direction.

Here, a hydraulic cylinder according to a comparative example of this embodiment is shown in FIG. 8. As shown in FIG. 8, with the hydraulic cylinder according to the comparative example, the check seal 60 is accommodated in the accommodating groove 65 so as to form a gap 80 between the bottom portion 66 of the accommodating groove 65 and the piston 30. In the case in which the check seal 60 is accommodated in the accommodating groove 65 so as to form the gap 80, when the pressure of the working oil is guided through the connection gap 71, the pressure of the working oil also acts on an end surface of the check seal 60 on the cushion bearing 40 side through the radial groove 63 and the axial groove 62. In this case, because the forces acting on both end surfaces of the check seal 60 in the axial direction by the pressure of the working oil are balanced, there may be a case in which the check seal 60 is not pressed against the cushion bearing 40 and the annular gap 70 cannot be sealed.

In contrast, with the hydraulic cylinder 100, the check seal 60 is accommodated in the accommodating groove 65 by being compressed in the axial direction. Therefore, except for the case in which the hydraulic cylinder 100 is in an abnormal state, which will be described later, as shown in FIG. 5, it is possible to reliably seal the annular gap 70 by always bringing the check seal 60 into contact with the bottom portion 66 of the accommodating groove 65.

The annular gap 70 inside the cushion bearing 40 is sealed by the check seal 60, and thereby, the communication between the annular gap 70 inside the cushion bearing 40 and the connection gap 71 inside the piston 30 is shut off. Therefore, the pressure of the working oil that has been guided through the connection gap 71 is prevented from being guided to the annular gap 70.

The communication between the annular gap 70 and the rod side chamber 2 is shut off by clamping the cushion bearing 40 between the step portion 13 of the piston rod 10 and the piston 30 (see FIGS. 1 and 2). Thus, the flow of the working oil from the rod side chamber 2 to the annular gap 70 inside the cushion bearing 40 is also shut off.

As the piston rod 10 is extended and approaches the stroke end, the cushion bearing 40 enters the inside of the bearing receiving portion 51 of the cylinder head 50 (see FIGS. 1 and 2). With such a configuration, the cushion passage 4 is formed by an outer circumferential surface of the cushion bearing 40 and an inner circumferential surface of the bearing receiving portion 51. Because resistance is imparted by the cushion passage 4 to the flow of the working oil discharged from the rod side chamber 2 through the supply/discharge port 52, the pressure drop in the rod side chamber 2 is suppressed, and the piston rod 10 is decelerated. By doing so, the cushioning operation is exhibited at the vicinity of the stroke end when the piston rod 10 is extended.

In addition, because the flow of the working oil to the annular gap 70 inside the cushion bearing 40 is shut off by the check seal 60, the cushion bearing 40 is prevented from being expanded in the radial direction by the pressure in the annular gap 70. Therefore, the cushion passage 4 is also prevented from being narrowed, and it is possible to exhibit the stable cushioning operation.

When the hydraulic pressure source is communicated with the rod side chamber 2 and the tank is communicated with the bottom-side chamber 3, the working oil is supplied to the rod side chamber 2, and the working oil in the bottom-side chamber 3 is discharged to the tank. Therefore, the hydraulic cylinder 100 is contracted.

In addition, due to the weight of the bucket attached to the piston rod 10, a force acts on the hydraulic cylinder 100 in the extending direction. With the hydraulic cylinder 100 that drives the bucket, the rod side chamber 2 is a load-side pressure chamber on which the load pressure by the load (the bucket) acts. The mutual communication between the rod side chamber 2 and the bottom-side chamber 3 is shut off by the cushion bearing 40 that is clamped between the step portion 13 of the piston rod 10 and the piston 30. Therefore, when supply/discharge of the working oil to/from the hydraulic cylinder 100 is stopped, the hydraulic cylinder 100 is in a load-holding state in which the load pressure acting on the rod side chamber 2 is held so as to immobilize the bucket, which is the load.

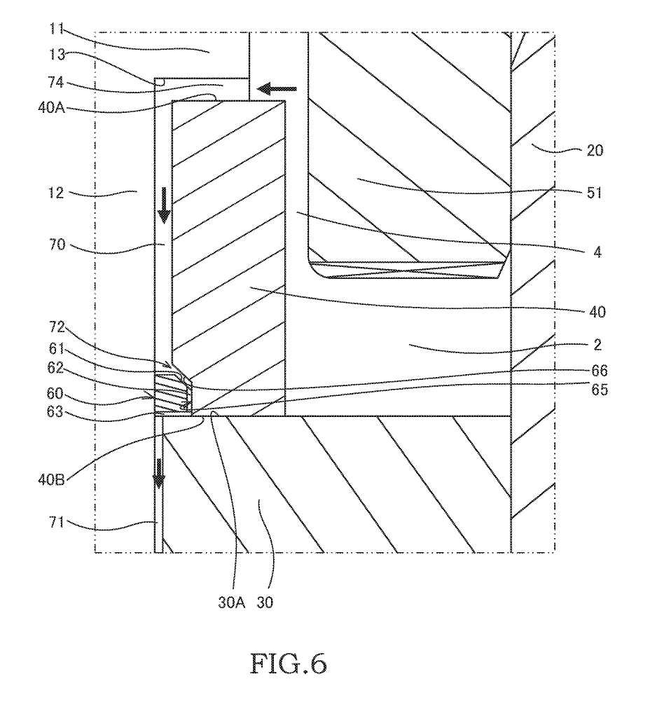

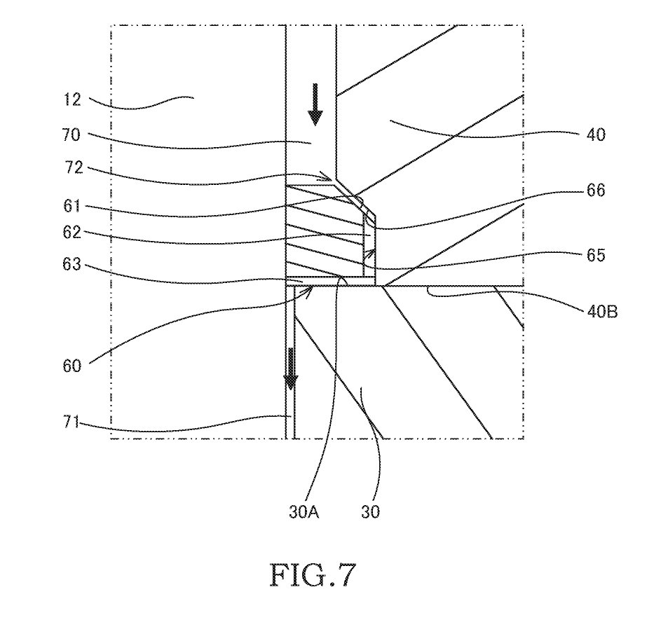

Here, when an excessive external force is exerted to the piston rod 10, the piston rod 10 may be elongated by being plastically deformed. The hydraulic cylinder 100 has an abnormality detecting function that detects such an abnormal state in which the piston rod 10 is plastically deformed. In the following, the abnormality detecting function of the hydraulic cylinder 100 will be described with reference to FIGS. 6 and 7.

As shown in FIG. 6, when the piston rod 10 is plastically deformed in the direction in which the piston rod 10 is elongated, an axial gap 74 is formed between the cushion bearing 40 and the step portion 13 of the piston rod 10 that are arranged in the axial direction. When such an axial gap 74 is formed so as to be adjacent to the cushion bearing 40, the rod side chamber 2 is communicated with the annular gap 70 through the axial gap 74.

In such an abnormal state, when the load-holding state is achieved by stopping supply/discharge of the working oil to/from the hydraulic cylinder 100, the load pressure in the rod side chamber 2 is guided to the annular gap 70 through the axial gap 74. By the load pressure that is guided through the annular gap 70, the check seal 60 is compressed and the check seal 60 is pressed towards the piston 30 side. At this time, the cushion bearing 40 is also pressed towards the piston 30.

As shown in FIG. 7, when the check seal 60 is compressed and pressed towards the piston 30 side, an in-groove gap 72 is formed in the accommodating groove 65 between the tapered portion 61 of the check seal 60 and the bottom portion 66 of the accommodating groove 65. The in-groove gap 72 is communicated with the axial groove 62 and the radial groove 63 of the check seal 60. Therefore, the annular gap 70 is communicated with the connection gap 71 via the in-groove gap 72, the axial groove 62, and the radial groove 63. As described above, the axial groove 62 and the radial groove 63 serve as a communicating passage through which the connection gap 71 is communicated with the in-groove gap 72.

Therefore, the load pressure in the rod side chamber 2 is guided to the bottom-side chamber 3 through the annular gap 70, the in-groove gap 72, the axial groove 62 and the radial groove 63 serving as the communicating passage, and the connection gap 71. As described above, at the time of the abnormal state, the check seal 60 forms the in-groove gap 72 by the load pressure guided from the annular gap 70 and allows the flow of the working oil from the rod side chamber 2 towards the bottom-side chamber 3 by the in-groove gap 72, and the axial groove 62 and the radial groove 63.

Therefore, in the abnormal state, even when supply/ discharge of the working oil to/from the hydraulic cylinder 100 is stopped, a small amount of the working oil is guided from the rod side chamber 2 to the bottom-side chamber 3 through the connection gap 71, causing the hydraulic cylinder 100 to extend by a small amount. Therefore, an operator can detect the abnormal state in which the piston rod 10 is deformed by checking whether the hydraulic cylinder 100 is extended in the load-holding state.

As described above, the check seal 60 has a checking function that shuts off the flow of the working oil from the connection gap 71 towards the rod side chamber 2 through the annular gap 70, and, when an abnormality has occurred, allows the flow of the working oil from the annular gap 70 towards the bottom-side chamber 3 through the connection gap 71. With such a configuration, it is possible to prevent the cushion bearing 40 from being expanded in the radial direction in the normal state without deteriorating the abnormality detecting function in which, when the abnormality has occurred, the hydraulic cylinder 100 is allowed to extend slightly in the load-holding state by causing the rod side chamber 2 to communicate with the bottom-side chamber 3.

According to the embodiment mentioned above, the advantages described below are afforded.

With the hydraulic cylinder 100, because the flow of the working oil from the connection gap 71 towards the rod side chamber 2 through the annular gap 70 is shut off by the check seal 60, the working oil is prevented from being guided to the inside of the cushion bearing 40. Thus, the cushion bearing 40 is prevented from being expanded outwards in the radial direction, and the cushion passage 4 formed at the vicinity of the stroke end is prevented from being narrowed. In addition, because the check seal 60 allows the flow of the working oil from the annular gap 70 towards the bottom-side chamber 3 through the connection gap 71, when the abnormality, in which the piston rod 10 is plastically deformed and elongated in the axial direction, has occurred, the working oil is guided from the rod side chamber 2 to the bottom-side chamber 3 through the check seal 60. Therefore, without deteriorating the abnormality detecting function of the hydraulic cylinder 100 having the clamped-type cushion bearing 40, the cushion passage 4 is prevented from being narrowed. Therefore, according to the hydraulic cylinder 100, it is possible to improve the stability of the cushioning operation of the hydraulic cylinder 100 having the clamped-type cushion bearing 40.

In addition, with the hydraulic cylinder 100, the check seal 60 is provided in the accommodating groove 65 that is formed from the opposing surface 40B of the cushion bearing 40 opposing the piston 30. As described above, by providing the check seal 60 on the piston 30 side, the working oil is prevented from being guided to the annular gap 70 over the entirety in the axial direction. Therefore, it is possible to further improve the stability of the cushioning operation.

In addition, because the check seal 60 is accommodated in the accommodating groove 65 in a state compressed in the axial direction, except for the case in which the abnormality has occurred, the check seal 60 is always brought into contact with the bottom portion 66 of the accommodating groove 65. Therefore, it is possible to reliably seal the annular gap 70.

The configurations, operations, and effects of the embodiment of the present invention will be collectively described below.

The hydraulic cylinder 100 includes: the piston rod 10 having the annular step portion 13 formed on the outer circumferential surface of the piston rod 10; the cylinder tube 20 through which the piston rod 10 is inserted; the piston 30 that is connected to the tip end of the piston rod 10, defines the rod side chamber 2 and the bottom-side chamber 3 in the interior of the cylinder tube 20, and slides along the inner circumferential surface of the cylinder tube 20; the cylindrical cushion bearing 40 that is clamped between the piston 30 and the step portion 13 of the piston rod 10 and provided so as to form the annular gap 70 on the outer circumference of the piston rod 10; the bearing receiving portion 51 into which the cushion bearing 40 is allowed to enter at the vicinity of the stroke end of the piston rod 10; the cushion passage 4 that is formed between the cushion bearing 40 and the bearing receiving portion 51 when the cushion bearing 40 enters the inside of the bearing receiving portion 51 at the vicinity of stroke end and that imparts resistance to the flow of the working oil passing therethrough; and the check seal 60 that is provided between the inner circumference of the cushion bearing 40 and the outer circumference of the piston rod 10. In the hydraulic cylinder 100, the flow of the working oil towards the rod side chamber 2 through the annular gap 70 from the connection gap 71, which is formed between the piston rod 10 and the piston 30, is shut off by the check seal 60, and the flow of the working oil from the annular gap 70 towards the bottom-side chamber 3 through the connection gap 71 is allowed.

In this configuration, because the flow of the working oil from the connection gap 71 towards the rod side chamber 2 through the annular gap 70 is shut off by the check seal 60, the working oil is suppressed from being guided to the inside of the cushion bearing 40. Thus, the cushion bearing 40 is suppressed from being expanded outwards in the radial direction, and the cushion passage 4 formed at the vicinity of stroke end is prevented from being narrowed. In addition, because the check seal 60 allows the flow of the working oil from the annular gap 70 towards the bottom-side chamber 3 through the connection gap 71, when the abnormality, in which the piston rod 10 is plastically deformed in the axial direction, has occurred, the working oil is guided from the rod side chamber 2 to the bottom-side chamber 3 through the check seal 60. Therefore, without deteriorating the abnormality detecting function of the hydraulic cylinder 100 having the clamped-type cushion bearing 40, which is clamped between the piston 30 and the step portion 13 of the piston rod 10, the cushion passage 4 is prevented from being narrowed.

With this configuration, it is possible to improve the stability of the cushioning operation of the hydraulic cylinder 100 having the abnormality detecting function.

In addition, in the hydraulic cylinder 100, the check seal 60 is provided in the accommodating groove 65 that is formed in the opposing surface 40B of the end surfaces of the cushion bearing 40 opposing the piston 30.

In this configuration, by providing the check seal 60 in the opposing surface 40B of the cushion bearing 40 opposing the piston 30, the working oil is prevented from being guided to the annular gap 70 over the entirety in the axial direction, and the cushion passage 4 is prevented from being narrowed.

With this configuration, it is possible to further improve the stability of the cushioning operation of the hydraulic cylinder 100 having the clamped-type cushion bearing 40.

In addition, with the hydraulic cylinder 100, the in-groove gap 72 is formed inside the accommodating groove 65 as the check seal 60 is pressed towards the piston 30 side by the pressure of the working oil guided through the annular gap 70, and the check seal 60 has the communicating passage (the axial groove 62 and the radial groove 63) through which the connection gap 71 is communicated with the in-groove gap 72.

In this configuration, because the in-groove gap 72 is formed by the pressure of the working oil from the annular gap 70 and the check seal 60 has the communicating passage (the axial groove 62 and the radial groove 63), the annular gap 70 is communicated with the connection gap 71. Thus, the check seal 60 allows the flow of the working oil from the annular gap 70 towards the bottom-side chamber 3 through the connection gap 71.

In addition, in the hydraulic cylinder 100, the communicating passage has the axial groove 62 that is formed on the outer circumferential surface of the check seal 60 along the axial direction and that communicates with the in-groove gap 72 and the radial groove 63 that is formed on the end surface of the check seal 60 on the piston 30 side and through which the axial groove 62 is communicated with the connection gap 71.

In this configuration, the in-groove gap 72 is communicated with the connection gap 71 by the axial groove 62 and the radial groove 63 of the communicating passage. Thus, the check seal 60 allows the flow of the working oil from the annular gap 70 towards the bottom-side chamber 3 through the connection gap 71.

In addition, in the hydraulic cylinder 100, the check seal 60 has the tapered portion 61 at which the outer diameter is gradually increased along the axial direction from the one end portion in the axial direction.

With this configuration, it is possible to prevent misassembly of the check seal 60.

In addition, in the hydraulic cylinder 100, the bottom portion 66 of the accommodating groove 65 in the axial direction is formed to have a tapered shape corresponding to the tapered portion 61 of the check seal 60.

In this configuration, the tapered portion 61 of the check seal 60 and the bottom portion 66 of the accommodating groove 65 are in surface contact with each other at the tapered surfaces.

With this configuration, it is possible to prevent misassembly of the check seal 60 and to improve the sealing performance of the annular gap 70 by the check seal 60.

In addition, in the hydraulic cylinder 100, the check seal 60 is accommodated in the accommodating groove 65 in a state compressed in the axial direction.

In this configuration, except for the case in which the hydraulic cylinder 100 is in the abnormal state, the check seal 60 is always brought into contact with the bottom portion 66 of the accommodating groove 65.

With this configuration, it is possible to reliably seal the annular gap 70 by the check seal 60.

Embodiments of this invention were described above, but the above embodiments are merely examples of applications of this invention, and the technical scope of this invention is not limited to the specific constitutions of the above embodiments.

In the above-mentioned embodiment, although the working oil is used as the working fluid, instead of this configuration, for example, aqueous alternative fluid etc. may be used.

In addition, in the above-mentioned embodiment, the check seal 60 has the tapered portion 61. Instead of this configuration, the check seal 60 may have, for example, a circular section or other polygonal section. In addition, the accommodating groove 65 is not limited to that having the bottom portion 66, and the accommodating groove 65 may be formed to have any shape.

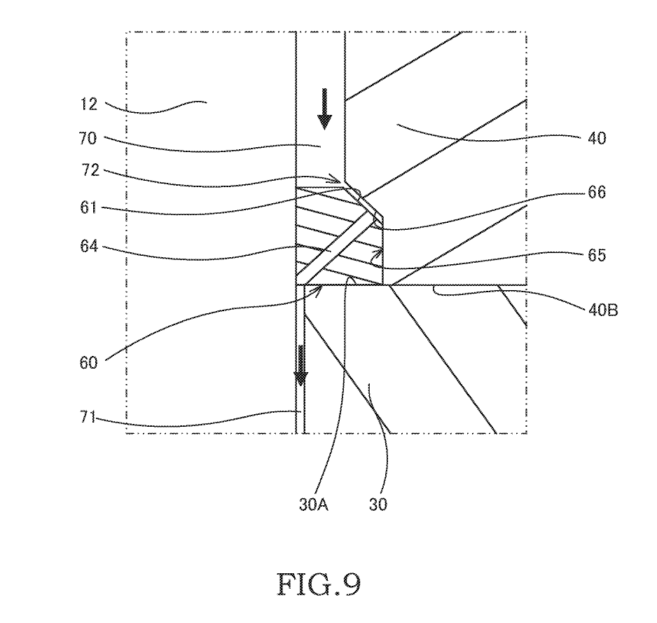

In addition, the communicating passage is not limited to that having the axial groove 62 and the radial groove 63, and the communicating passage may be formed to have any shape as long as the connection gap 71 is communicated with the in-groove gap 72. For example, as shown in FIG. 9, the communicating passage may be formed as a single through hole 64 that penetrates through the check seal 60 such that the connection gap 71 is communicated with the in-groove gap 72.

In addition, in the above-mentioned embodiment, the accommodating groove 65 is formed from the opposing surface 40B of the cushion bearing 40 opposing the piston 30. In order to prevent the working oil from being guided to the annular gap 70 inside the cushion bearing 40 over the entirety in the axial direction, it is desirable that the accommodating groove 65 is formed at a position at which the cushion bearing 40 and the piston 30 face against with each other. However, the configuration is not limited thereto, and for example, the accommodating groove 65 may be provided in the central portion of the cushion bearing 40 in the axial direction. Also in this case, it is possible to prevent the working oil from being guided to a part of the annular gap 70, in other words, to the gap between the step portion 13 of the piston rod 10 and the check seal 60, and thereby, it is possible to suppress the expansion of the cushion bearing 40 in the radial direction by the pressure of the working oil.

In addition, in the above-mentioned embodiment, the check seal 60 is provided in the accommodating groove 65 that is formed from the opposing surface 40B of the cushion bearing 40 opposing the piston 30. Instead of this configuration, the check seal 60 may be provided between the inner circumference of the piston 30 and the outer circumference of the piston rod 10. In other words, an accommodating groove may be formed in the inner circumference of the piston 30. In this case, it is possible to prevent the working oil from being guided over the entirety of the annular gap 70 without providing an accommodating groove so as to open at the opposing surface 30A of the piston 30 opposing the cushion bearing 40. As described above, even in a case in which the check seal 60 is provided in the accommodating groove formed in the inner circumference of the piston 30, the similar effects as those of the above-mentioned embodiment can be afforded.

This application claims priority based on Japanese Patent Application No.2015-24358 filed with the Japan Patent Office on Feb. 10, 2015, the entire contents of which are incorporated into this specification.

1. A fluid pressure cylinder comprising:
a piston rod having an annular step portion formed on an outer circumferential surface;
a cylinder tube into which the piston rod is inserted;
a piston connected to a tip end of the piston rod, the piston being configured to slide along an inner circumferential surface of the cylinder tube, the piston defining a rod side chamber and a bottom-side chamber in an interior of the cylinder tube and;
a cylindrical cushion bearing clamped between the piston and the step portion of the piston rod, the cushion bearing being provided so as to form an annular gap on the outer circumference of the piston rod;
a bearing receiving portion into which the cushion bearing is allowed to enter at vicinity of a stroke end of the piston rod;
a cushion passage formed between the cushion bearing and the bearing receiving portion as the cushion bearing enters inside of the bearing receiving portion, the cushion passage being configured to impart resistance to flow of working fluid passing therethrough; and
a check seal provided between an inner circumference of the cushion bearing or the piston and the outer circumference of the piston rod; wherein
the check seal shuts off the flow of the working fluid from a connection gap between the piston rod and the piston towards the rod side chamber through the annular gap and allows the flow of the working fluid from the annular gap towards the bottom-side chamber through the connection gap.

2. The fluid pressure cylinder according to claim 1, wherein
the check seal is accommodated in an accommodating groove formed in an opposing surface of end surfaces of the cushion bearing, the opposing surface opposing the piston.

3. The fluid pressure cylinder according to claim 2, wherein
an in-groove gap is formed in the accommodating groove as the check seal is pressed towards the piston side by pressure of the working fluid guided through the annular gap, and
the check seal has a communicating passage through which the connection gap is communicated with the in-groove gap.

4. The fluid pressure cylinder according to claim 3, wherein
the communicating passage has
an axial groove formed in an outer circumferential surface of the check seal along axial direction, the axial groove being communicated with the in-groove gap; and
a radial groove formed in an end surface of the check seal on the piston side, the radial groove being configured to allow the axial groove to communicate with the connection gap.

5. The fluid pressure cylinder according to claim 2, wherein
the check seal has a tapered portion at which an outer diameter is gradually increased along the axial direction from one end surface in the axial direction.

6. The fluid pressure cylinder according to claim 5, wherein
a bottom portion of the accommodating groove in the axial direction is formed to have a tapered shape corresponding to the tapered portion of the check seal.

7. The fluid pressure cylinder according to claim 2, wherein
the check seal is accommodated in the accommodating groove in a state compressed in the axial direction.
